(19) United States
(12) Patent Application Publication
(10) Pub. No.: US 2016/0246918 A1
(43) Pub. Date: Aug. 25, 2016

(54) INFORMATION PROCESSING APPARATUS AND SIMULATION METHOD

(71) Applicants: FUJITSU LIMITED, Kawasaki-shi (JP); University of Tsukuba, Tsukuba-shi (JP)

(72) Inventors: Tomotake NAKAMURA, Numazu (JP); Yasuteru SHIGETA, Ibaraki (JP); Ryuhei Harada, Ibaraki (JP)

(73) Assignees: Fujitsu Limited, Kawasaki-shi (JP); University of Tsukuba, Tsukuba-shi (JP)

(21) Appl. No.: 15/012,146

(22) Filed: Feb. 1, 2016

(30) Foreign Application Priority Data
Feb. 20, 2015 (JP) 2015-032321

(51) Int. Cl. G06F 19/12; G06F 17/50

(52) U.S. Cl. CPC G06F 19/12; G06F 17/5009

(57) ABSTRACT

An information processing apparatus includes: an outlying structure detecting unit that uses a certain outlier detection method to detect, from a distribution of molecular structures in a structural space, molecular structures deviating from others; an outlying degree specifying unit that specifies outlying degrees for the respective detected molecular structures; and an MD simulation executing unit that executes molecular simulations with initial structures set to the molecular structures to which weights are assigned in such a manner that a larger weight is assigned to a molecular structure for which the higher outlying degree has been specified.

### CROSS-REFERENCE TO RELATED APPLICATION

This application is based upon and claims the benefit of priority of the prior Japanese Patent Application No. 2015-032321, filed on Feb. 20, 2015, the entire contents of which are incorporated herein by reference.

### FIELD

The embodiment discussed therein is related to, for example, an information processing apparatus.

### BACKGROUND

MD (molecular dynamics) simulations are widely used as a method in computational science for analyzing structural changes of biomolecules. MD simulations are a tool for evaluating biologically important reactions.

Various methods have been proposed for MD simulation-based analysis of functions of biomolecules. For example, in an MD simulation, an initial arrangement of molecules is determined, and an initial state is set up by assigning a charge to each atom contained in the molecules. Calculations are then made to obtain how the respective molecules move through bonding interaction and non-bonding interaction and how energies in the system change as a result of the movement. Executing MD simulations starting from a large number of initial arrangements can result in determination of the most stable arrangement of the molecules (for example, refer to Japanese Laid-open Patent Publication No. 2007-080044).

Such MD simulations may be used for examining structural changes of a protein.

At the same time, there are outlier detection methods for detecting, from a set data, an outlier that does not have similar data elements therein (for example, refer to Ryuhei Harada, Tomotake Nakamura, Yu Takano, and Yasuteru Shigeta, “Protein Folding Pathways Extracted by OFLOOD: Outlier FLOODing Method,” Journal of Computational Chemistry 2014, DOI:10.1002/JCC.23773, “http://onlinelibrary.wiley.com/doi/10.1002/jcc.23773/abstract”). The outlier detection methods include methods based on a distribution, methods based on a depth, methods based on a distance, methods based on a density, and methods based on clustering. The outlier detection methods include FlexDice as an example of a method based on clustering. In FlexDice, local data spaces in a data space are calculated, data elements in the continuous local data spaces that have high data densities are collected into a cluster, and data elements in the local data space that has a low data density are collected into one cluster as noise.

Use of FlexDice and MD simulations enables searching for structural changes of a protein. For example, as the first process, a trajectory of a protein that is obtained by executing an MD simulation is projected into reaction coordinates, so that the distribution thereof in a structural space is found. As the second process, outlying structures are detected with respect to the distribution by use of FlexDice. As the third process, an MD simulation with an initial structure set to each of the outlying structures is executed. Subsequently, the structure searching is repeated until the distribution converges while the distribution is updated by use of trajectories obtained by executing MD simulations.

With this technique, executing MD simulations for a long period of time is needed to extract structural changes of a protein. However, a structural change of a protein that relates to a biological function is a rare event, which is rarely induced and has a low probability of occurrence in a stochastic process. There is no guarantee that executing MD simulations for a long period of time can result in extraction of such a rare event.

### SUMMARY

According to an aspect of an embodiment, an information processing apparatus includes a processor. The processor executes detecting, by a certain outlier detection method, any molecular structures deviating from others in a distribution of molecular structures in a structural space. The processor executes specifying outlying degrees for the respective molecular structures detected at the detecting. The processor executes executing molecular simulations with initial structures set to the molecular structures to which weights are assigned in such a manner that a larger weight is assigned to a molecular structure for which the higher outlying degree has been specified at the specifying.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating the configuration of an information processing apparatus according to an embodiment;

FIG. 2 is a diagram illustrating a flowchart of an MD simulation process according to the embodiment;

FIG. 3 is a diagram illustrating a flowchart of an outlying structure detecting process according to the embodiment;

FIG. 4A is a diagram (1) illustrating a specific example of outlying structure detection according to the embodiment;

FIG. 4B is a diagram (2) illustrating the specific example of the outlying structure detection according to the embodiment;

FIG. 4C is a diagram (3) illustrating the specific example of the outlying structure detection according to the embodiment;

FIG. 4D is a diagram (4) illustrating the specific example of the outlying structure detection according to the embodiment;

FIG. 4E is a diagram (5) illustrating the specific example of the outlying structure detection according to the embodiment;

FIG. 4F is a diagram (6) illustrating the specific example of the outlying structure detection according to the embodiment;

FIG. 4G is a diagram (7) illustrating the specific example of the outlying structure detection according to the embodiment;

FIG. 5 is a diagram illustrating a result of MD simulations executed without consideration given to outlying degrees;

FIG. 6 is a diagram illustrating a result of an MD simulations executed with consideration given to outlying degrees; and

FIG. 7 is a diagram illustrating one example of a computer that executes a simulation program.

### DESCRIPTION OF EMBODIMENT

Preferred embodiments of the present invention will be explained with reference to accompanying drawings. The present invention is not limited to the embodiment.

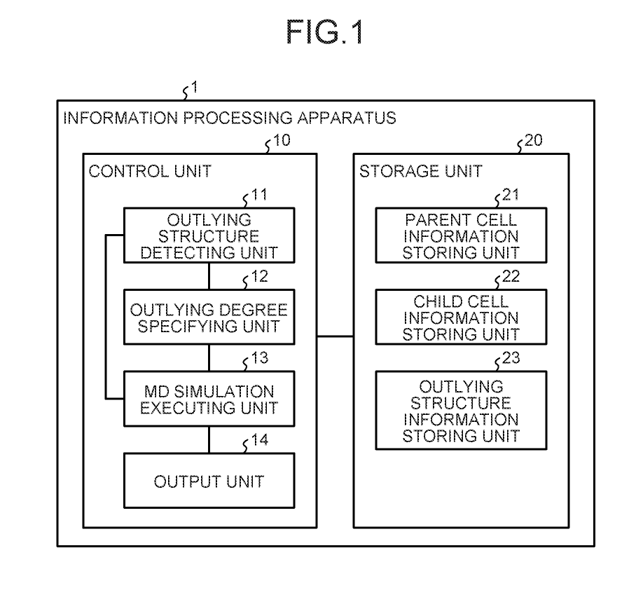

FIG. 1 is a functional block diagram illustrating the configuration of an information processing apparatus according to an embodiment. An information processing apparatus 1 illustrated in FIG. 1 facilitates, by an outlier detection method, extraction of a rare event related to manifestation of a biological function in protein. For the facilitation, the information processing apparatus 1 uses an outlier detection method to detect an initial structure in an MD simulation that is expected to be high in transition probability indicating likelihood of inducing a rare event. More specifically, this is because an initial structure expected to be high in transition probability indicating likelihood of inducing a rare event is presumed deviating from other molecular structures. When having detected an initial structure by the outlier detection method, the information processing apparatus 1 defines, with respect to the initial structure, an outlying degree as a degree of a transition probability indicating likelihood of the inducing. The information processing apparatus 1 then executes MD simulations in which a higher weight is given to an initial structure determined to have a high outlying degree (be high in transition probability indicating likelihood of the inducing). In other words, the information processing apparatus 1 executes MD simulations with consideration given to outlying degrees. In the following description, a molecular structure (an initial structure) detected by an outlier detection method may be referred to as an “outlying structure.” A molecular structure may be referred to as a “data element”.

The information processing apparatus 1 includes a control unit 10 and a storage unit 20.

The control unit 10 corresponds to an electronic circuit such as a central processing unit (CPU). The control unit 10 includes an internal memory for storing therein programs that define various processing procedures and control data, and executes various processes using the programs and the data. The control unit 10 includes an outlying structure detecting unit 11, an outlying degree specifying unit 12, an MD simulation executing unit 13, and an output unit 14.

The storage unit 20 is, for example, a semiconductor memory element such as a random access memory (RAM) or a flash memory, or a storage device such as a hard disk or an optical disc. The storage unit 20 includes a parent cell information storing unit 21, a child cell information storing unit 22, and an outlying structure information storing unit 23.

The parent cell information storing unit 21 stores therein information on parent cells that is used in detecting an outlying structure. The child cell information storing unit 22 stores therein information on child cells that is used in detecting an outlying structure. The parent cell information storing unit 21 and the child cell information storing unit 22 are used by, for example, the outlying structure detecting unit 11.

The outlying structure information storing unit 23 stores therein information on outlying structures. Information on outlying structures includes information on the outlying structures and information on outlying degrees assigned to the outlying structures. The outlying structure information storing unit 23 is used by, for example, the outlying degree specifying unit 12 and the MD simulation executing unit 13.

The outlying structure detecting unit 11 detects, by an outlier detection method, a molecular structure deviating from others in a distribution of molecular structures in a structural space. As an outlier detection method according to the embodiment, a method obtained by extending FlexDice, which is a method based on clustering is applied, for example.

For example, the outlying structure detecting unit 11 detects, by the outlier detection method, an outlying structure among molecular structures in each hierarchical layer in a distribution of molecular structures in a structural space. In one example, the outlying structure detecting unit 11 separates molecular structures in a parent cell in a structural space, that is, subjects the molecular structures to 2^{D} division, thereby creating child cells in spaces into which the molecular structures have been separated. A cell herein means a data space that is a D-dimensional rectangular parallelepiped in a structural space. A parent cell herein means a cell that is located in a higher hierarchical layer than child cells. Specifically, in the case where the structural space is a two-dimensional space, the outlying structure detecting unit 11 creates a child cell in any space that is obtained by dividing a parent cell into four and that contains any molecular structure.

The outlying structure detecting unit 11 determines, depending on the density of molecular structures, whether each child cell is a sparse cell, a dense cell, or a medium cell. Here, cells are categorized into dense cells, medium cells, and sparse cells in accordance with the densities of molecular structures. A density herein means the number of elements per D dimensional cube each side of which has a unit length. In one example, in hierarchical layers other than the lowermost layer, a dense cell means a cell having a density equal to or higher than a threshold MAX. A medium cell means a cell having a density equal to or higher than the threshold MIN and lower than the threshold MAX. A sparse cell means a cell having a density lower than the threshold MIN. In the lowermost layer, no medium cell is generated, and a dense cell means a cell having a density equal to or higher than a threshold MEAN. A sparse cell means a cell having a density lower than the threshold MEAN. The respective thresholds are automatically or manually provided as input parameters for the outlier detection method. The outlying structure detecting unit 11 then detects, as an outlying structure, any data element contained in a child cell that has been determined to be a sparse cell.

Although the above description assumes that the outlying structure detecting unit 11 applies, as the outlier detection method, an extended FlexDice method, this is not a limiting example. Any outlier detection method that enables detection of outlying degrees may be applied.

The outlying degree specifying unit 12 specifies an outlying degree with respect to each outlying structure. For example, the outlying degree specifying unit 12 collects data elements from any child cells determined to be sparse cells in order to assign outlying degrees to the outlying structures. The collected data elements are noise, and are sets of outliers. The sets of outliers are collected with respect to each hierarchical layer. The outlying degree specifying unit 12 then specifies an outlying degree with respect to each set of outliers.

A description is now given of outlying degrees. Outlying degrees are specified by use of hierarchical layers. In other words, in a lower hierarchical layer (as the layer number of a hierarchical layer is larger), the outlying degree of a data element in a child cell determined to be a sparse cell in the hierarchical layer is lower. More specifically, in a lower hierarchical layer (as the layer number of a hierarchical layer is larger), an outlying structure is detected nearer to stable structures, and the outlying degree of the outlying structure is therefore lower. In contrast, in a higher hierarchical layer (as the layer number of a hierarchical layer is smaller), an outlying structure is detected more apart from stable structures, and the outlying degree of the outlying structure is therefore higher. Outlying degrees can be thus specified by use of hierarchical layers. When outlying structures are detected in a layer 0 through the lowermost layer k, the outlying degree of an outlying structure detected in a layer 1, for example, is “1”. The outlying degree of an outlying structure detected in a layer k−1 is “k−1”. The outlying degree of an outlying structure detected in the layer k is “k”. A lower outlying degree is assigned to an outlying structure in a hierarchical layer closer to the layer k. A higher outlying degree is assigned to an outlying structure in a hierarchical layer closer to the layer 0.

The MD simulation executing unit 13 executes MD simulations with initial structures set to outlying structure to which outlying degrees have been assigned. For example, the MD simulation executing unit 13 executes MD simulations with initial structures set to outlying structures to which weights are assigned in such a manner that a larger weight is assigned to an outlying structure having a higher outlying degree. In one example, the MD simulation executing unit 13 assigns weights in such a manner that: a certain weight is assigned to an outlying structure having the lowest outlying degree; a weight twice as large as the certain weight is assigned to an outlying structure having the second lowest outlying degree; and a weight three times as large as the certain weight is assigned to an outlying structure having the third lowest outlying degree. The MD simulation executing unit 13 then executes MD simulations through redistribution of initial velocities with initial structures set to the weighted outlying structures. The MD simulations, the number of which corresponds to the number of outlying structures, are executed independently from each other.

The MD simulation executing unit 13 updates a distribution of molecular structures in a structural space by using trajectories obtained by the execution. The MD simulation executing unit 13 ends execution of MD simulations once the distribution of molecular structures in the structural space converges. The MD simulation executing unit 13 transfers to the outlying structure detecting unit 11 if the distribution of molecular structures in the structural space does not converge. For the MD simulations, a representative tool such as Amber is used.

The output unit 14 outputs plots obtained by projecting, into the structural space, trajectories obtained through the execution by the MD simulation executing unit 13. The structural space into which the trajectories are projected is, for example, a coordinate space of the highest two dimensions in an N-dimensional principal component coordinate space. However, the structural space into which the trajectories are projected may be a coordinate space of the highest three dimensions or may be the N-dimensional principal component coordinate space.

Flowchart of MD Simulation Process

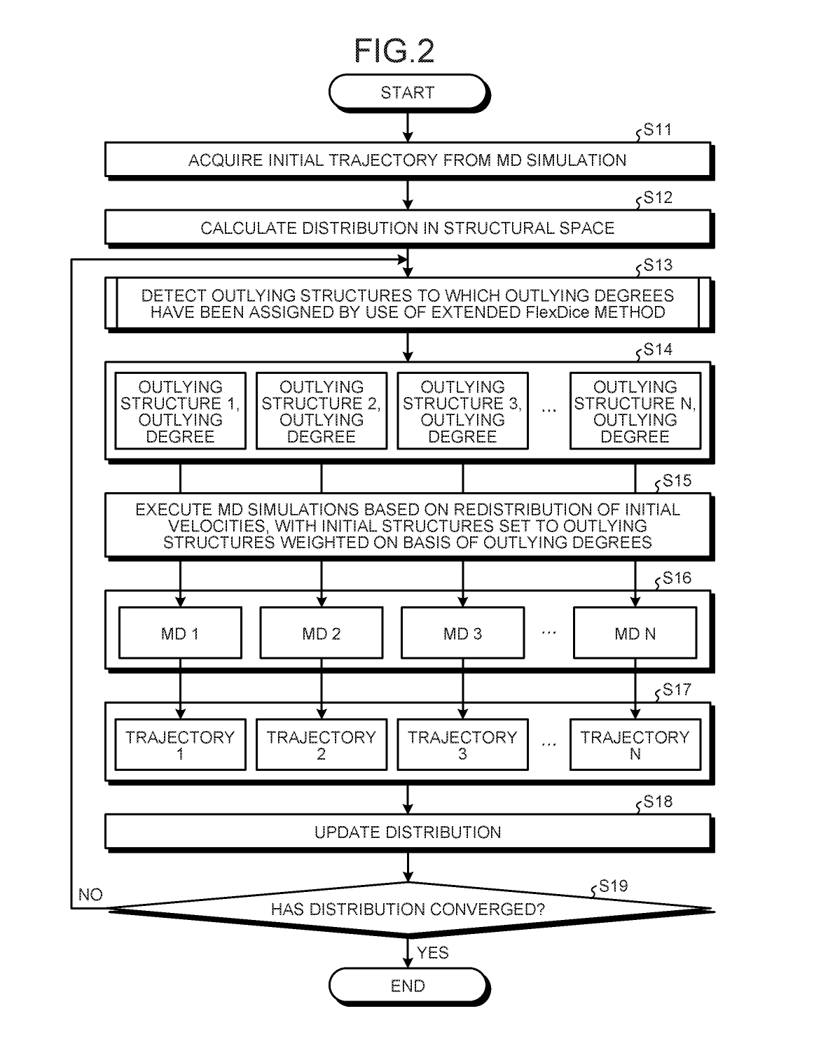

FIG. 2 is a diagram illustrating a flowchart of an MD simulation process according to the embodiment. The following describes, as one example, a case where the MD simulation process is intended to extract a structural change in a molecular structure of a protein.

In the beginning, the MD simulation executing unit 13 having an initial structure input thereto executes an MD simulation to acquire a trajectory of a protein obtained through the execution (Step S11). The MD simulation executing unit 13 then projects the acquired trajectory into reaction coordinates and calculates a distribution of molecular structures of the protein in a structural space (Step S12).

Subsequently, the outlying structure detecting unit 11 detects outlying structures to which outlying degrees have been assigned by use of an extended FlexDice method (Step S13). A flowchart of an outlying structure detecting process is to be described later.

Subsequently, the MD simulation executing unit 13 receives the outlying structures, to which outlying degrees have been assigned, that have been detected by the outlying structure detecting unit 11 (Step S14). Here, it is assumed that the number of the received outlying structures to which outlying degrees have been assigned is N. N is a natural number greater than 3. However, N may be 1 or 2, and may be any number that is the number of outlying structures having been detected.

The MD simulation executing unit 13 then executes MD simulations through redistribution of initial velocities with initial structures set to the outlying structures weighted in accordance with their outlying degrees (Step S15). The MD simulation executing unit 13 executes the mutually independent MD simulations the number of which is N (Step S16).

The MD simulation executing unit 13 acquire N trajectories of the protein that have been obtained as a result of the execution (Step S17). The MD simulation executing unit 13 calculates a distribution of molecular structures of the protein in the structural space by using the acquired N trajectories, and updates the calculated distribution (Step S18).

The MD simulation executing unit 13 determines whether the updated distribution has converged (Step S19). If it is determined that the updated distribution has not converged (No at Step S19), the MD simulation executing unit 13 proceeds to Step S13 to detect outlying structures based on this distribution to which outlying degrees are assigned. In other words, the MD simulation executing unit 13 repeats detection of outlying structures and searching for structural changes (structure searching) through MD simulations while updating a distribution of molecular structures of the protein in the structural space.

On the other hand, if it is determined that the updated distribution has converged (Yes at Step S19), the MD simulation executing unit 13 ends the MD simulation process. Thereafter, the output unit 14 outputs plots obtained by projecting, into the structural space, trajectories obtained upon convergence of the distribution.

Flowchart of Outlying Structure Detecting Process

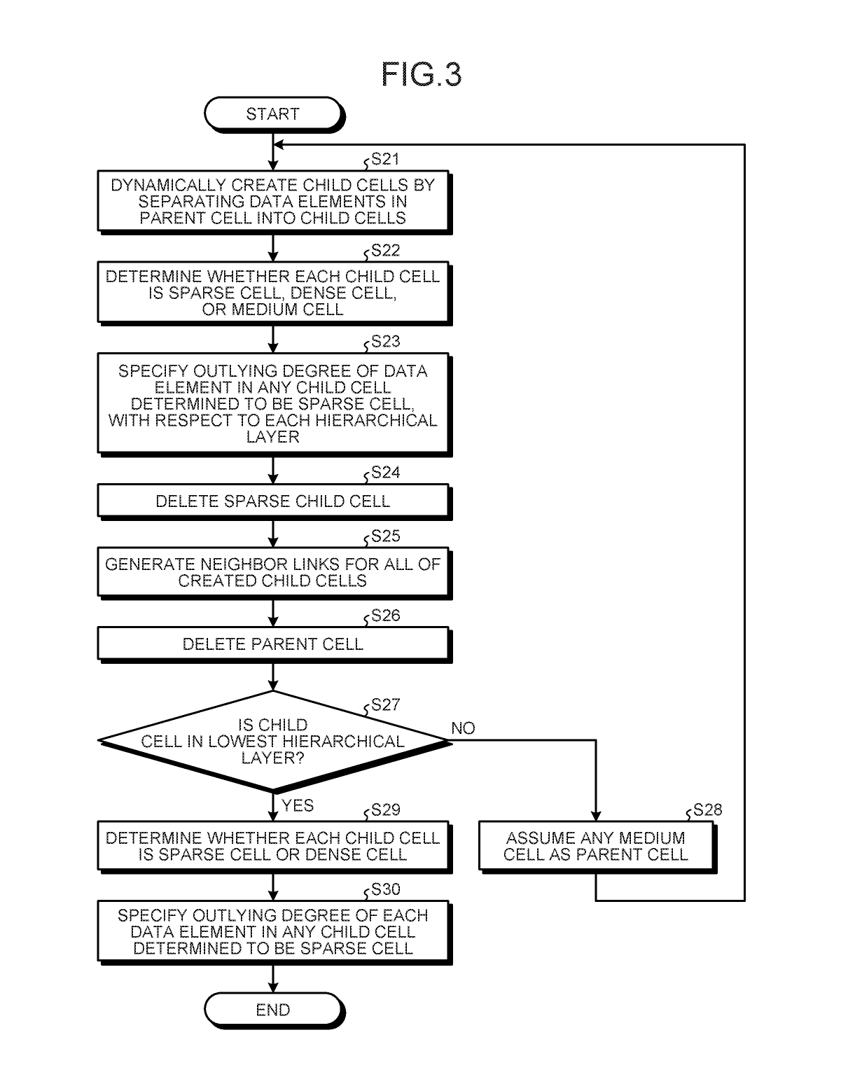

FIG. 3 is a diagram illustrating a flowchart of the outlying structure detecting process according to the embodiment. FIG. 3 uses the term data element for molecular structure of a protein. In addition, input parameters to be provided into the outlying structure detecting process include the threshold MAX, the threshold MIN, the threshold MEAN, and the maximum layer number of the lowermost layer.

As illustrated in FIG. 3, the outlying structure detecting unit 11 dynamically creates child cells by separating data elements in a parent cell in the structural space into the child cells (Step S21). For example, when the structural space is a two-dimensional space, the outlying structure detecting unit 11 divides a medium cell generated in the layer k into four and separating data elements in the medium cell into cells in the layer k+1. The medium cell in the layer k corresponds to the parent cell, and the cells in the layer k+1 correspond to the child cells.

The outlying structure detecting unit 11 determines whether each of the child cells is a sparse cell, a dense cell, or a medium cell (Step S22). For example, the outlying structure detecting unit 11 determines the child cell to be a dense cell if the density thereof is equal to or higher than the threshold MAX. The outlying structure detecting unit 11 determines the child cell to be a medium cell if the density thereof is equal to or higher than the threshold MIN and lower than the threshold MAX. The outlying structure detecting unit 11 determines the child cell to be a sparse cell if the density thereof is lower than the threshold MIN.

The outlying degree specifying unit 12 then specifies an outlying degree of a data element in any child cell determined to be a sparse cell, with respect to each hierarchical layer (Step S23). For example, the outlying degree specifying unit 12 assumes data elements in any child cell determined to be a sparse cell as noise and collects them into one group. The group into which such data elements are collected is an outlier set in a hierarchical layer containing the child cells. The outlying degree specifying unit 12 specifies an outlying degree for data elements collected into the group, as the hierarchical layer.

Subsequently, the outlying structure detecting unit 11 deletes any sparse child cell (Step S24). This deletion is intended to increase a free space in the storage unit 20. The outlying structure detecting unit 11 then stores any data element that has been contained in the sparse child cell into the outlying structure information storing unit 23, in one example.

The outlying structure detecting unit 11 then generates neighbor links for all of child cells that have been created (Step S25). In other words, the outlying structure detecting unit 11 links together neighboring child cells among dense cells and medium cells. Neighbor links are generated also between cells in different hierarchical layers.

The outlying structure detecting unit 11 then deletes the parent cell (Step S26).

Subsequently, the outlying structure detecting unit 11 determines whether the child cells are in the lowermost layer (Step S27). For example, the outlying structure detecting unit 11 determines whether the layer number of a hierarchical layer containing the child cells is the maximum layer number of the lowermost layer. If it is determined that the child cell is not in the lowermost layer (No at Step S27), the outlying structure detecting unit 11 assumes a medium cell as a parent cell (Step S28), and then proceeds to Step S21 so as to search for a sparse cell in the next hierarchical layer.

On the other hand, if it is determined that the child cell is in the lowermost layer (Yes at Step S27), the outlying structure detecting unit 11 determines whether the child cell is a sparse cell or a dense cell (Step S29). For example, the outlying structure detecting unit 11 determines the child cell to be a dense cell if the density thereof is equal to or higher than the threshold MEAN. The outlying structure detecting unit 11 determines the child cell to be a sparse cell if the density thereof is lower than the threshold MEAN.

The outlying degree specifying unit 12 then specifies an outlying degree of each data element in any child cell determined to be a sparse cell, with respect to the lowermost layer (Step S30). The outlying structure detecting unit 11 then ends the outlying structure detecting process.

Specific Example of Outlying Structure Detection

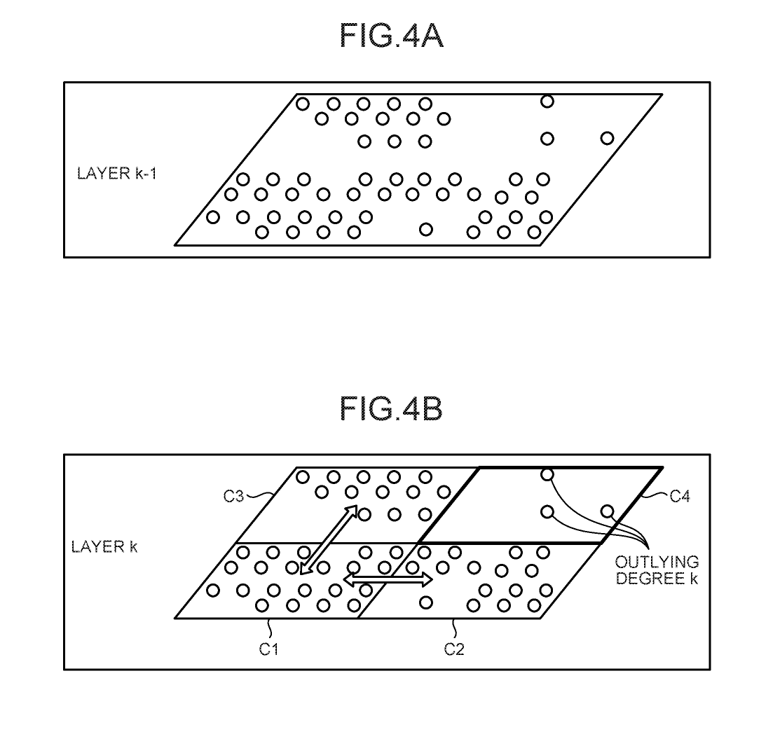

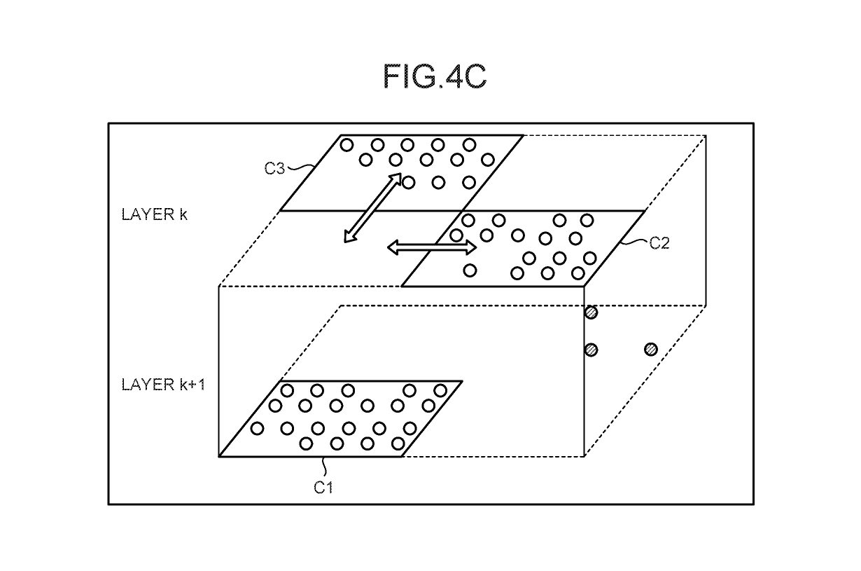

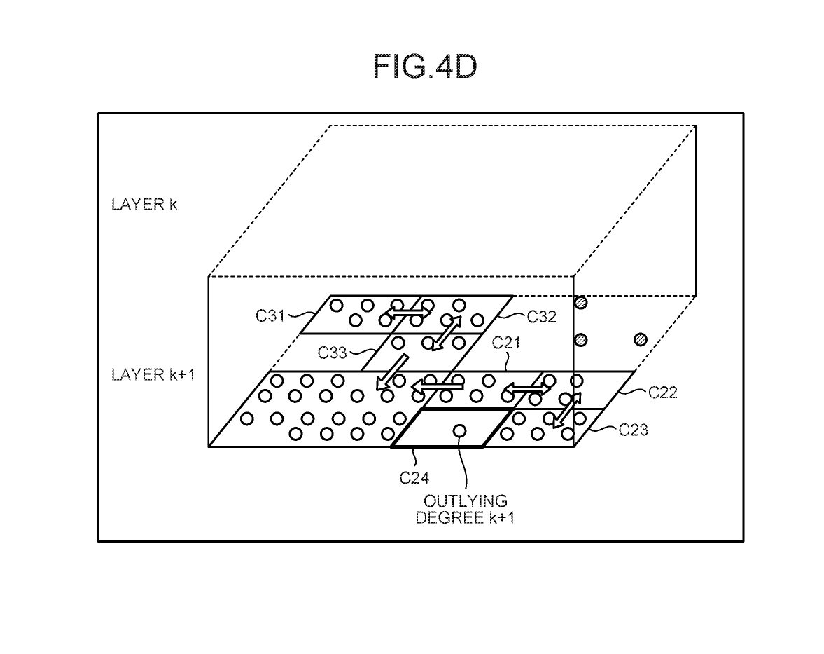

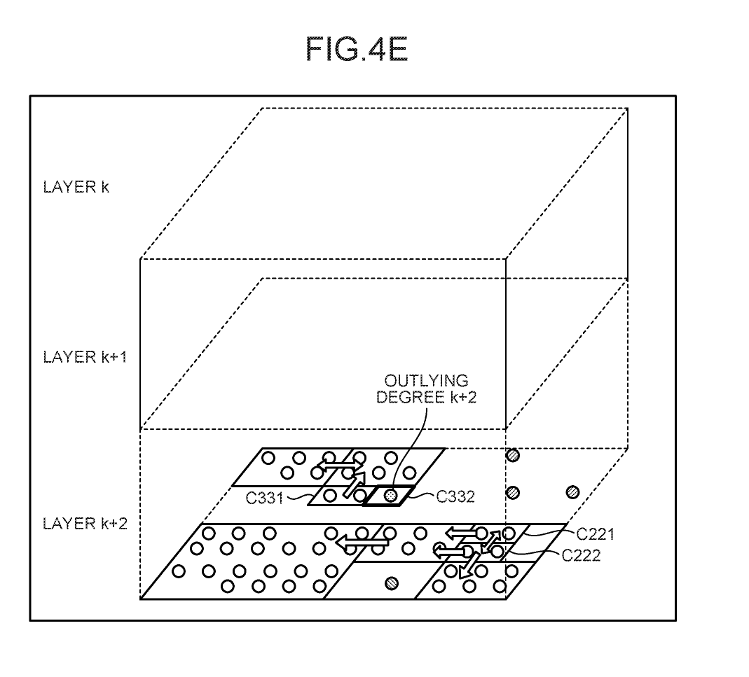

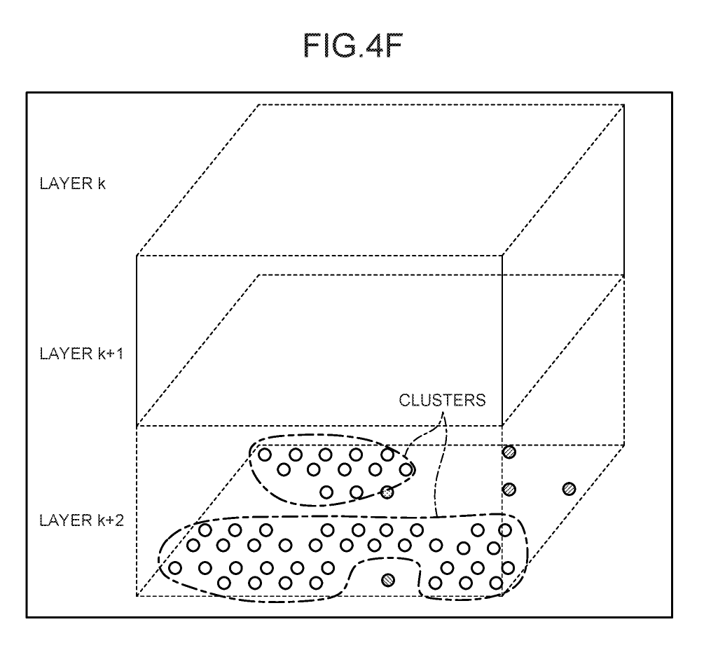

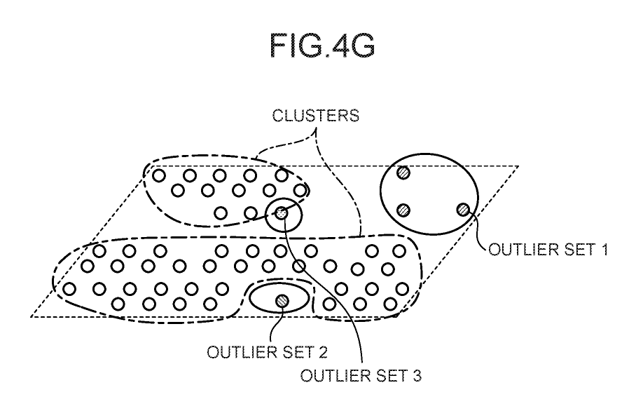

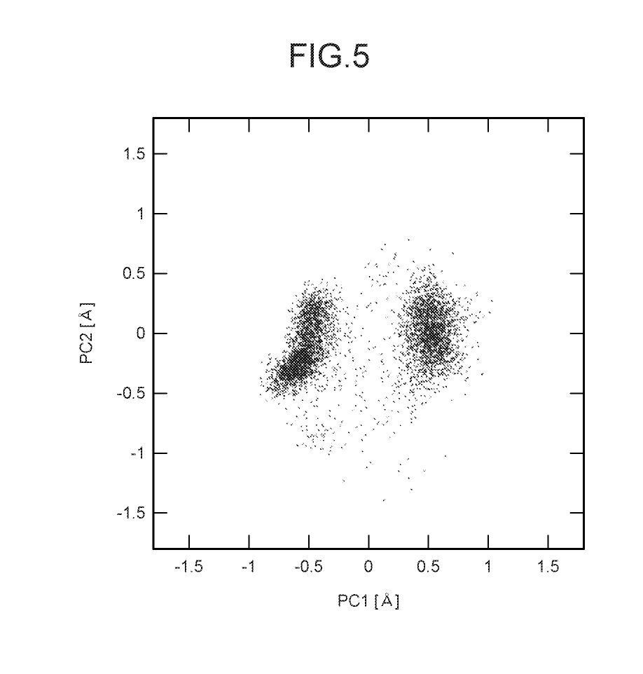

FIG. 4A to FIG. 4G are diagrams illustrating a specific example of outlying structure detection according to the embodiment. In each of FIG. 4A to FIG. 4G, it is assumed that the structural space is a two-dimensional space. In a data space, the outlying structure detecting unit 11 repeats division of cells determined to be medium cells from a layer 0 through a layer k+2, thereby creating new cells, where k+2 is provided as an input parameter and represents the maximum layer number of the lowermost layer.

FIG. 4A illustrates a cell determined to be a medium cell in a layer k−1. The cell contains a plurality of data elements corresponding to molecular structures of a protein. One circle denotes one data element. Under this situation, the outlying structure detecting unit 11 assumes the medium cell in the layer k−1 as a parent cell, and divides this parent cell into four. The outlying structure detecting unit 11 then separates data elements in the parent cell into cells in a layer k, thereby dynamically creating child cells.

FIG. 4B illustrates the child cells created in the layer k. The outlying structure detecting unit 11 determines whether each of the child cells is a sparse cell, a dense cell, or a medium cell. Here, it is assumed that the child cell indicated by reference sign C1, the child cells indicated by reference signs C2 and C3, and the child cell indicated by the reference sign C4 have been determined to be a dense cell, medium cells, and a sparse cell, respectively.

The outlying degree specifying unit 12 then specifies the outlying degree of each data element contained in the child cell determined to be a sparse cell. Here, the outlying degree of the data element contained in the child cell indicated by reference sign C4 is specified as “k”, which is the layer number of the hierarchical layer. The outlying structure detecting unit 11 then deletes the sparse child cell C4 in the layer k and stores data elements having been contained in this sparse child cell.

The outlying structure detecting unit 11 then generates neighbor links for the dense cells and the medium cells. A double arrow indicates that a neighbor link has been generated between cells present in the same hierarchical layer.

FIG. 4C illustrates the dense cell C1, which has been already determined to be a dense cell in the layer k, in a layer k+1. The medium cells C2 and C3 are illustrated in the layer k. This diagram indicates that the data elements having been contained in the child cell C4 determined to be a sparse cell have been stored. Under this situation, the outlying structure detecting unit 11 assumes each of the medium cells in the layer k as a parent cell, and divides the parent cell into four. The outlying structure detecting unit 11 then separates the data elements in the parent cell into cells in the layer k+1, thereby dynamically creating child cells.

FIG. 4D illustrates the child cells created in the layer k+1 from the cells C2 and C3 determined to be medium cells. The outlying structure detecting unit 11 determines whether each of the child cells is a sparse cell, a dense cell, or a medium cell. Here, it is assumed that, with respect to the cell C2, the child cells indicated by reference signs C21 and C23, the child cell indicated by reference sign C22, and the child cell indicated by reference sign C24 have been determined to be dense cells, a medium cell, and a sparse cell, respectively. It is assumed that, with respect to the cell C3, the child cells indicated by reference signs C31 and C32 and the child cell indicated by reference sign C33 have been determined to be dense cells and a medium cell, respectively. It is assumed that none of the child cells has been determined to be a sparse cell.

The outlying degree specifying unit 12 then specifies the outlying degree of a data element contained in the child cell determined to be a sparse cell. Here, the outlying degree of the data element contained in the child cell indicated by reference sign C24 is specified as “k+1”, which is the layer number of the hierarchical layer. The outlying structure detecting unit 11 then deletes the sparse child cell C24 in the layer k+1 and stores a data element having been contained in this sparse child cell.

The outlying structure detecting unit 11 then generates neighbor links for the dense cells and the medium cells. A double arrow indicates that a neighbor link has been generated between cells present in the same hierarchical layer. A single arrow indicates that a neighbor link has been generated between cells in different hierarchical layers.

FIG. 4E illustrates child cells created likewise in a layer k+2 from the cells C22 and C33 determined to be medium cells. Here, the layer k+2 is the lowermost layer the layer number of which is maximum, and the outlying structure detecting unit 11 therefore determines whether each of the child cells is a sparse cell or a dense cell. It is assumed that, with respect to the cell C22, the child cells indicated by reference signs C221 and C222 have been determined to be dense cells. It is assumed that none of the child cells has been determined to be a sparse cell. It is assumed that, with respect to the cell C33, the child cell indicated by reference sign C331 and the child cell indicated by reference sign C332 are a dense cell and a sparse cell, respectively.

The outlying degree specifying unit 12 then specifies the outlying degree of a data element contained in the child cell determined to be a sparse cell. Here, the outlying degree of the data element contained in the child cell indicated by reference sign C332 is specified as “k+2”, which is the layer number of the hierarchical layer.

The outlying structure detecting unit 11 then generates neighbor links for the dense cells and the medium cells. A double arrow indicates that a neighbor link has been generated between cells present in the same hierarchical layer. A single arrow indicates that a neighbor link has been generated between cells in different hierarchical layers.

As illustrated in FIG. 4F, the outlying structure detecting unit 11 then forms clusters each by collecting data elements in a dense cell and any other cells linked to the dense cell through the neighbor links.

Note that, as illustrated in FIG. 4G, the outlying degree specifying unit 12 generates a set of outliers with respect to each hierarchical layer when assigning outlying degrees to outlying structures. In other words, the outlying degree specifying unit 12 collects data elements (noise) contained in any child cells that have been determined to be sparse cells into one group with respect to each hierarchical layer. The outlying degree specifying unit 12 then specifies the outlying degree of each of the outlier sets. Here, noise contained in an outlier set 1 is data elements that have an outlying degree specified as “k”. Noise contained in an outlier set 2 is a data element that has an outlying degree specified as “k+1”. Noise contained in an outlier set 3 is a data element that has an outlying degree specified as “k+2”.

Results of MD Simulations

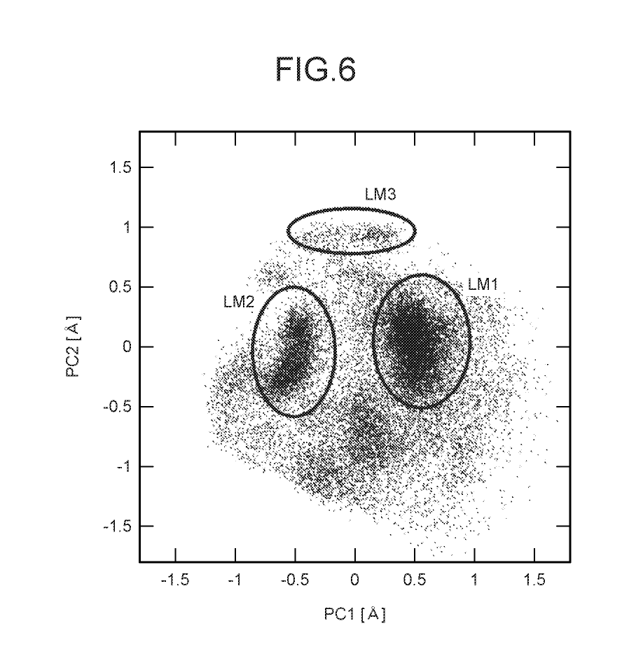

Next, results of MD simulations executed with the application of the FlexDice-based outlier detection method are described with reference to FIG. 5 and FIG. 6. FIG. 5 is a diagram illustrating a result of MD simulations executed without consideration given to outlying degrees. FIG. 6 is a diagram illustrating a result of an MD simulations executed with consideration given to outlying degrees.

FIG. 5 illustrates plots obtained by projecting, into a two-dimensional structural space, trajectories obtained through structure searching performed 15 times to which a FlexDice-based outlier detection method is applied (without consideration given to outlying degrees). Here, an X-coordinate PC1 and a Y-coordinate PC2 in FIG. 5 are coordinates of two dimensions that rank highest among those of a nine-dimensional principal component coordinate space. In addition, nine-dimensional original data was used in executing the outlier detection.

As illustrated in FIG. 5, a result of calculation performed without consideration given to outlying degrees is presented.

FIG. 6 illustrates plots obtained by projecting, into a two-dimensional structural space, trajectories obtained through structure searching performed 15 times to which the FlexDice-based outlier detection method is applied (with consideration given to outlying degrees). Here, an X-coordinate PC1 and a Y-coordinate PC2 in FIG. 6 are coordinates in two dimensions that rank highest among those of a nine-dimensional principal component coordinate space. In addition, the same nine-dimensional original data as that used in the case of FIG. 5 was used in executing the outlier detection. For this execution, the MD simulation executing unit 13 assigns a certain weight to an outlying structure having the lowest outlying degree among outlying structures detected by the outlying structure detecting unit 11, that is, an outlying structure detected in the lowermost layer; assigns a weight twice as large as the certain weight to an outlying structure in the second lowermost layer, that is, an outlying structure detected in a hierarchical layer that is immediately higher than the lowermost one; and assigns a weight three times as large as the certain weight to an outlying structure in the third lowermost layer, that is, an outlying structure detected in a hierarchical layer that is immediately higher than the second lowermost one. MD simulations with initial structures thereof set to outlying structures to which weights are thus assigned are executed through redistribution of initial velocities.

As illustrated in FIG. 6, a result of calculation performed with consideration given to outlying degrees is presented. The result indicates that giving consideration to outlying degrees enables sampling from circled regions from which sampling was impossible in the case of FIG. 5. More specifically, the MD simulation executing unit 13 that gives consideration to outlying degrees enables sampling from a wider range in a structural space than in a case where it gives no consideration to outlying degrees. In particular, stable structures LM3 are structures that were impossible to detect through long-time MD simulations and through MD simulations without consideration given to outlying degrees. Thus, the MD simulation executing unit 13 that gives consideration to outlying degrees can efficiently detect rare events.

Effects of Embodiment

According to the above embodiment, the information processing apparatus 1 uses a certain outlier detection method to detect any molecular structures deviating from others in a distribution of molecular structures in a structural space. The information processing apparatus 1 specifies outlying degrees for the detected molecular structures. The information processing apparatus 1 executes molecular simulations with initial structures set to molecular structures to which weights are assigned in such a manner that a larger weight is assigned to a molecular structure for which the specified outlying degree is higher. This configuration enables the information processing apparatus 1 to, by executing molecular simulations with initial structures set to molecular structures to which weights are assigned in such a manner that a larger weight is assigned to a molecular structure for which the outlying degree is higher, facilitate occurrence of a structural change in a molecular structure that has a low probability of occurrence and reduce the time it takes to extract the structural change.

According to the above embodiment, the information processing apparatus 1 detects, by using an outlier detection method using hierarchical layers, any molecular structures deviating from others with respect to each hierarchical layer. The information processing apparatus 1 specifies, for the detected molecular structures, outlying degrees according to corresponding hierarchical layers. This configuration enables the information processing apparatus 1 to easily execute molecular simulations with consideration given to outlying degrees as a result of setting the outlying degrees to corresponding hierarchical layers. In other words, being capable of detecting an outlying structure nearer to stable structures and specifying the outlying degree of the outlying structure as a lower outlying degree in a lower hierarchical layer, the information processing apparatus 1 can easily execute molecular simulations with consideration given to outlying degrees.

Furthermore, in the above embodiment, the information processing apparatus 1 separates, into spaces in a second hierarchical layer immediately lower than a first hierarchical layer in a structural space, molecular structures in a partial space that is contained in the first hierarchical layer and that has a medium density. The information processing apparatus 1 determines whether each of the spaces is a partial space that is high, a partial space that is low, or a partial space that is medium, in density of molecular structures in the second hierarchical layer. The information processing apparatus 1 thus detects molecular structures contained in a partial space that is low in the density. This configuration enables the information processing apparatus 1 to detect molecular structures contained in a partial space that is low in the density and thereby easily detect a molecular structure deviating from others.

Furthermore, in the above embodiment, the information processing apparatus 1 sets the outlying degree of a detected molecular structure higher as the hierarchical layer of the molecular structure is higher. This configuration enables the information processing apparatus 1 to, in a higher hierarchical layer, detect an outlying structure more apart from stable structures and thus set the outlying degree of the outlying structure higher. Consequently, the information processing apparatus 1 can facilitate occurrence of a structural change of a molecular structure that has a low probability of occurrence, by executing molecular simulations with consideration given to outlying degrees.

Other Issues

Each of the illustrated components of the information processing apparatus 1 is not always physically configured as illustrated in the drawings. In other words, how the information processing apparatus 1 is specifically distributed and integrated is not limited to the illustrated form, and the information processing apparatus 1 may be created with a part or the whole thereof functionally or physically distributed or integrated in any desired units in accordance with various loads and various statuses of use. For example, the outlying structure detecting unit 11 and the outlying degree specifying unit 12 may be integrated as one unit. Furthermore, the MD simulation executing unit 13 may be separated into a setting unit that weights outlying structures, and an execution unit that executes MD simulations in which outlying structures are set as initial structures. Furthermore, the storage unit 20 may be connected as an external device of the information processing apparatus 1 via a network.

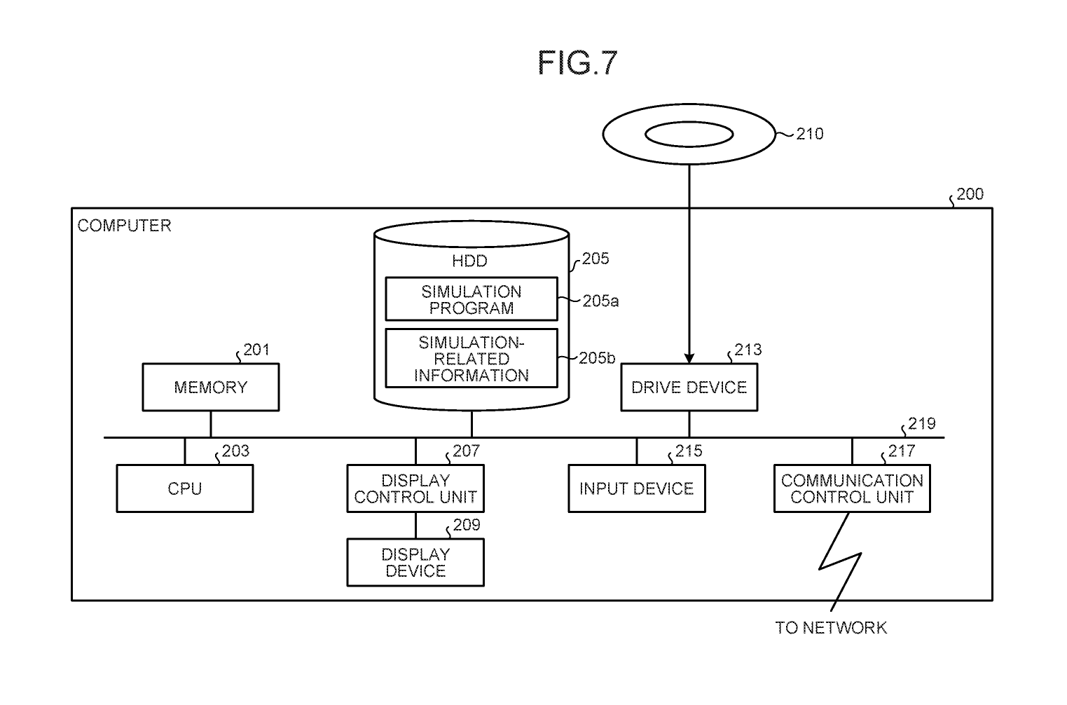

Furthermore, various pieces of processing described in the above embodiment can be implemented by causing a computer, such as a personal computer or a workstation, to execute previously prepared computer programs. For this reason, the following describes one example of a computer that implements the same functions as the information processing apparatus 1 illustrated in FIG. 1 and executes a simulation program. FIG. 7 is a diagram illustrating one example of a computer that executes a simulation program.

As illustrated in FIG. 7, a computer 200 includes a CPU 203, an input device 215 that accepts input of data from a user, and a display control unit 207 that controls a display device 209. The computer 200 further includes a drive device 213 that reads a program or the like from a storage medium, and a communication control unit 217 that exchanges data with another computer via a network. The computer 200 further includes a memory 201 that temporarily stores various kinds of information, and a hard disk drive (HDD) 205. The memory 201, the CPU 203, the HDD 205, the display control unit 207, the drive device 213, the input device 215, and the communication control unit 217 are connected to one another via a bus 219.

The drive device 213 is, for example, a device for a removable disk 210. The HDD 205 stores therein a simulation program 205a and simulation-related information 205b.

The CPU 203 reads out the simulation program 205a, loads it into the memory 201, and executes it as processes. These processes correspond to the respective functional units of the information processing apparatus 1. The simulation-related information 205b corresponds to the parent cell information storing unit 21, the child cell information storing unit 22, and the outlying structure information storing unit 23. For example, a removable disk 211 stores therein various kinds of information such as the simulation program 205a.

Furthermore, the simulation program 205a does not always need to be stored in the HDD 205 from the beginning. For example, the program is stored in a “portable physical medium” such as a flexible disk (FD), a compact disc read only memory (CD-ROM), a digital versatile disc (DVD), a magneto-optical disk, or an integrated circuit (IC) card that is inserted into the computer 200. The computer 200 may be configured to read the simulation program 205a from such a medium to execute it.

One implementation can facilitate efficient extraction of a rare event related to manifestation of a biological function in a protein by an outlier detection method.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a processor, wherein the processor executes:
detecting, by a certain outlier detection method, any molecular structures deviating from others in a distribution of molecular structures in a structural space;
specifying outlying degrees for the respective molecular structures detected at the detecting; and
executing molecular simulations with initial structures set to the molecular structures to which weights are assigned in such a manner that a larger weight is assigned to a molecular structure for which the higher outlying degree has been specified at the specifying.

2. The information processing apparatus according to claim 1, wherein
the detecting detects, by the outlier detection method using hierarchical layers, any molecular structures deviating from others with respect to each hierarchical layer, and
the specifying specifies outlying degrees of the respective molecular structures detected at the detecting, according to the hierarchical layers.

3. The information processing apparatus according to claim 2, wherein the detecting separates molecular structures in a first partial space in a first hierarchical layer within the structural space into spaces in a second hierarchical layer immediately lower than the first hierarchical layer, determines whether each of the spaces is a partial space that is high, a partial space that is low, or a partial space that is medium, in density of molecular structures in the second hierarchical layer, and detects molecular structures contained in any of the spaces that has been determined to be the partial space that is low in the density, the first partial space being medium in density of molecular structures.

4. The information processing apparatus according to claim 2, wherein the specifying sets the outlying degree higher for the molecular structure detected at the detecting that is in a higher hierarchical layer.

5. The information processing apparatus according to claim 1, wherein the outlier detection method is a method by which the outlying degrees are specified.

6. A non-transitory computer-readable recording medium having stored therein a simulation program that causes a computer to execute a process the process comprising:
detecting, by a certain outlier detection method, any molecular structures deviating from others in a distribution of molecular structures in a structural space;
specifying outlying degrees for the respective molecular structures detected at the detecting; and
executing molecular simulations with initial structures set to the molecular structures to which weights are assigned in such a manner that a larger weight is assigned to a molecular structure for which the higher outlying degree has been specified at the specifying.

7. A simulation method executed by a computer, the method comprising:
detecting, by a certain outlier detection method, any molecular structures deviating from others in a distribution of molecular structures in a structural space using a processor;
specifying outlying degrees for the respective molecular structures detected at the detecting using the processor; and
executing molecular simulations with initial structures set to the molecular structures to which weights are assigned in such a manner that a larger weight is assigned to a molecular structure for which the higher outlying degree has been specified at the specifying using the processor.
